(19) United States
(12) Patent Application Publication
(10) Pub. No.: US 2010/0012539 A1
(43) Pub. Date: Jan. 21, 2010

(54) Combinable Cylindrical Tool Head Holder

(76) Inventor: Eupin WANG, Taipei County (TW)

Correspondence Address: Dr. BANGER SHIA, 102 Lindencrest Ct., Sugar Land, TX, 77479-5201, US

(21) Appl. No.: 12/371,604

(22) Filed: Feb. 15, 2009

(30) Foreign Application Priority Data
Jul. 15, 2008 (TW) 097126839

(51) Int. Cl. B25H 3/00

(52) U.S. Cl. 206/379

(57) ABSTRACT

A cylinder assembled tool head holder is made of plastic and comprises an inserting portion and an assembling portion. Plural holders can be pivotally assembled to one another though the neighboring inserting portions and assembling portions to define plural inserting spaces for insertion of tool heads. By such arrangements, a predetermined number of tool head holders can be assembled as desired for insertion of a corresponding number of tool heads, thus improving the convenience in carrying and use.

### BACKGROUND OF THE INVENTION

1. Field of the Invention

The present invention relates to a tool head holder; and more particularly to a combinable cylindrical tool head holder for storing, carrying and displaying the cylindrical tool heads such as drill bit, screwdriver bit, etc.

2. Description of the Prior Art

Referring to FIG. 1, a conventional tool head holder 10 comprises plural pivotally-assembled holding portions 11. The respective holding portions 11 are integrally formed with plural different specifications of insertion cylinders 111 for insertion of different tool heads A. The respective holding portions 11 are further formed with pivoting portions 12 for insertion of a pivot pin 13 to pivotally connect the respective holding portions 11, so that the holding portions 11 can be folded for storage to reduce the occupied space.

However, as for such a conventional tool head holder, although not every specification of tool head is needed during every operation, it is necessary for the user to carry all the tool heads, so that the unneeded tool heads actually occupy lots of carrying space of the user, thus causing much inconvenience. However, the respective holding portions 11 are assembled to each other through a pivot pin, thus increasing the material cost. In addition, the respective insertion cylinders 111 have a fixed specification, which correspondingly limit the specification or configuration of the tool heads to be inserted into the cylinders 111, so that the user cannot selectively carry the needed tool heads according to the actual requirements.

The present invention has arisen to mitigate and/or obviate the afore-described disadvantages.

### SUMMARY OF THE INVENTION

The primary objective of the present invention is to provide a combinable cylindrical tool head holder, which can improve the convenience in both carrying and use.

In order to achieve the above objective, a combinable cylindrical tool head holder in accordance with the present invention is made of plastic to have flexibility and comprises an inserting portion and an assembling portion. Plural holders can be pivotally assembled to one another through the neighboring inserting portions and assembling portions to define a corresponding number of inserting spaces for insertion of the cylindrical tool heads. The inserting portion is formed with an inserting tube, a hollow portion and an inserting cylinder from up down. The inserting tube is defined in an inner periphery thereof with an annular positioning groove adjacent to the hollow portion, and the inserting cylinder is also defined in an inner periphery with an annular positioning groove adjacent to the hollow portion. The assembling portion is located outside the hollow portion and in the form of a tube, and further the assembling portion is formed with an annular positioning edge at each of two opposite ends thereof. when two holders are assembled to each other, the assembling portion of a first holder is disposed in the hollow portion of a second holder, and the positioning edges of the first holder are engaged with the positioning grooves of the second holder, after assembly, the inserting tube and the inserting cylinder of the second holder and the assembling portion of the first holder will define an inserting space for insertion of a tool head

### BRIEF DESCRIPTION OF THE DRAWINGS

FIG. 1 is a perspective view of a conventional tool head holder;

FIG. 2 is a perspective view of a combinable cylindrical tool head holder in accordance with the present invention;

FIG. 3 is a top view of the combinable cylindrical tool head holder in accordance with the present invention;

FIG. 4 is an assembly view of the combinable cylindrical tool head holders in accordance with the present invention;

FIG. 5 is a perspective view illustrating how the combinable cylindrical tool head holders hold the cylindrical tool heads; and

FIG. 6 is a perspective view of a combinable cylindrical tool head holder in accordance with another embodiment of the present invention;

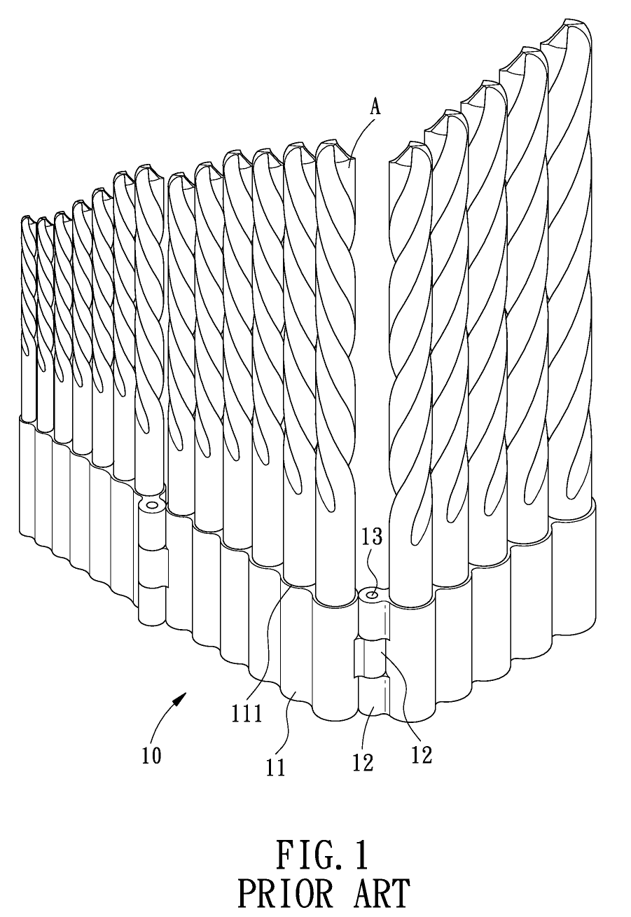

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

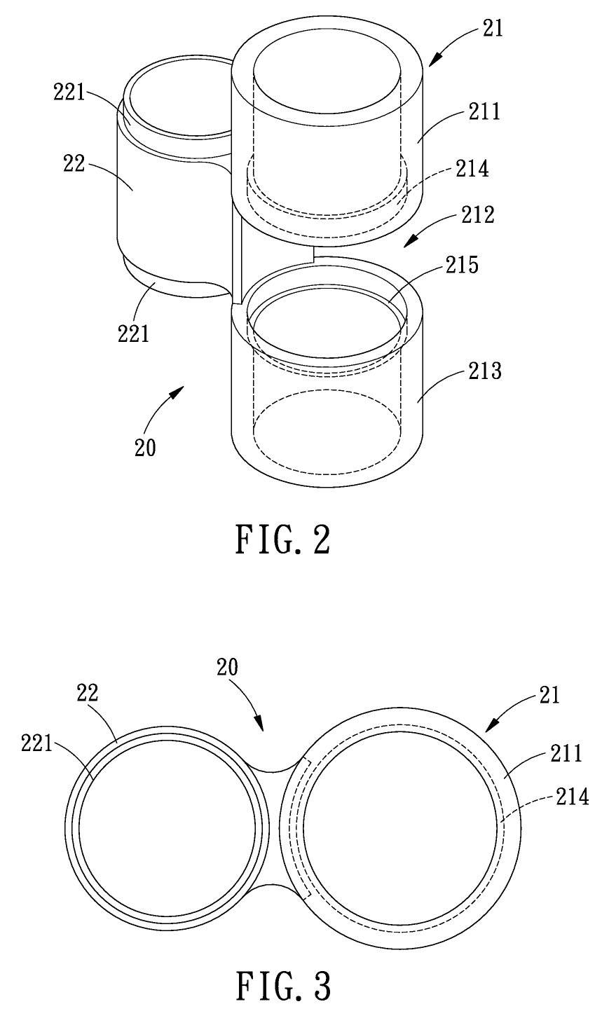

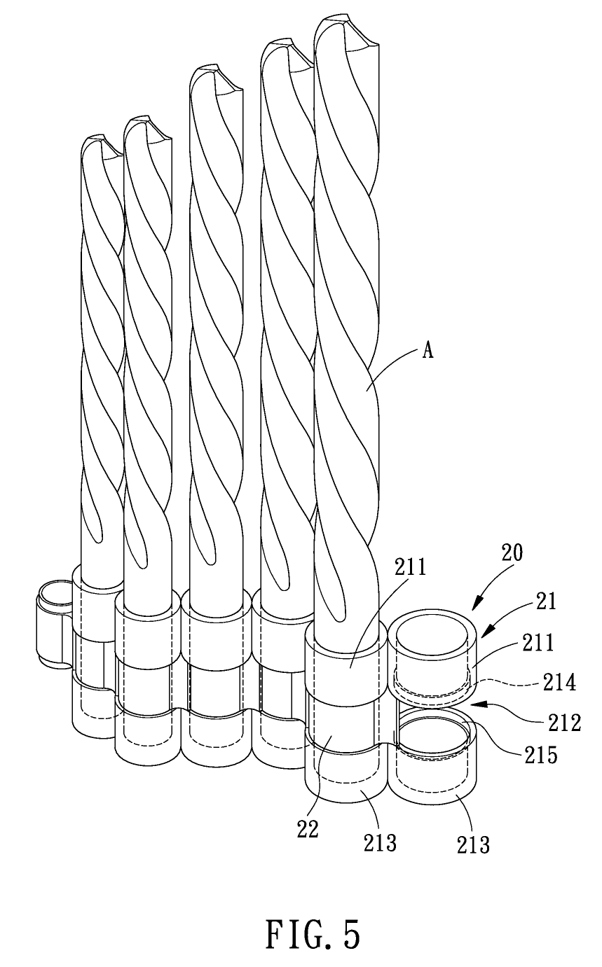

Referring to FIGS. 2-5, a combinable cylindrical tool head holder 20 in accordance with the present invention is made of plastic to have flexibility and comprises an inserting portion 21 and an assembling portion 22. Plural tool head holders 20 can be pivotally assembled to one another through the neighboring inserting portions and combining portions.

The inserting portion 21 is formed with an inserting tube 211, a hollow portion 212 and an inserting cylinder 213 from up down. The inserting tube 211 is defined in an inner periphery thereof with an annular positioning groove 214 adjacent to the hollow portion 212. The inserting cylinder 213 is defined in an inner periphery thereof with an annular positioning groove 215 adjacent to the hollow portion 212.

The assembling portion 22 is located outside the hollow portion 212 of the holder 20 and in the form of a tube. The assembling portion 22 is formed with an annular positioning edge 221 at each of two opposite ends thereof.

By such arrangements, when two holders are assembled, the assembling portion 22 of a first holder 201 will be disposed in the hollow portion 212 of a second holder 202 in such a manner that the positioning edges 221 of the first holder 201 can be engaged into the positioning grooves 214, 215 of the second holder 202. After the assembly of the two holders, the inserting tube 211 and the inserting cylinder 213 of the first holder 201 and the assembling portion 22 of the second holder 202 will define an inner inserting space for insertion of a tool head A.

The aforementioned is the key technology and the summary of the positional and structural relationship of the respective components of the preferred embodiment in accordance with the present invention.

For a better understanding of the present invention, its operation and function, reference should be made to the following description:

Referring to FIGS. 2-4 again, when the two holders 20 are assembled, it is required to slightly pull the inserting tube 211 and the inserting cylinder 213 of the second holder 202 in opposite directions to expand the hollow portion 212 of the second holder 202, so that the assembling portion 22 of the first holder 201 can be disposed in the hollow portion 212 of the second holder 202 successfully in such a manner that the positioning edges 221 of the first holder 201 are engaged into the positioning grooves 214, 215 of the second holder 202.

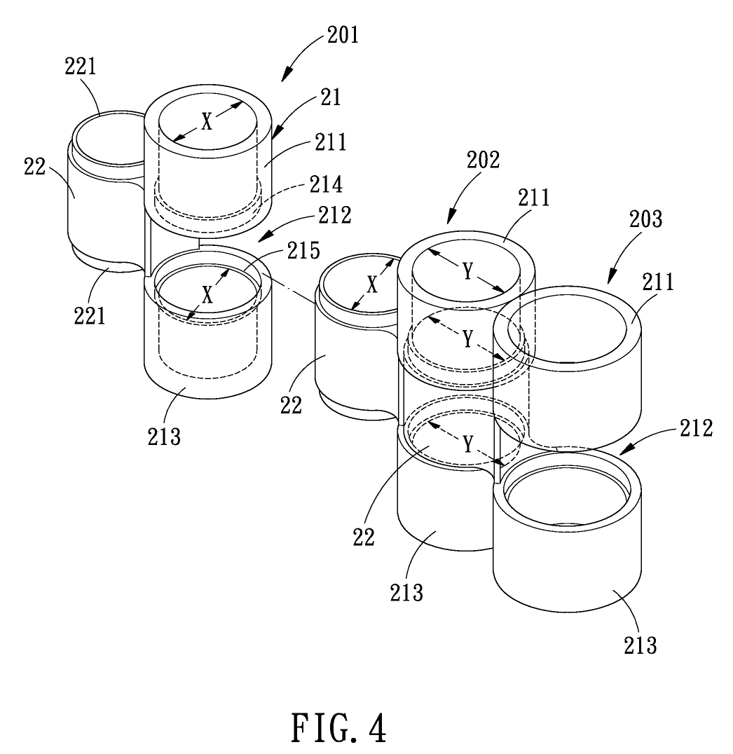

As shown in FIG. 4, the first holder 201 and the second holder 202 of the present invention are pivoted to each other through the positioning edges 221 and the positioning grooves 214, 215, so that when the tool head A is inserted into the inserting space defined by the inserting tube 211, the inserting cylinder 213 of the first holder 201 and the assembling portion 22 of the second holder 202, the first and the second holders 201, 202 can pivot with respect to each other, and further the tool head A can act as a shaft to increase the pivoting connection strength. With such arrangements, when plural holders are assembled, the respective joints have a fine rotation degree, and the overall assembled structure is quite stable and easy to carry.

It is to be noted that, the neighboring assembled holders can have different specifications as desired, for example, as shown in FIG. 4, the inserting tube 211 and the inserting cylinder 213 of the first holder 201 have a smaller aperture size X, and the assembling portion 22 of the second holder 202 also has the smaller aperture size X while the inserting tube 211 and the inserting cylinder 213 of the second holder 202 have a larger aperture size Y, and the assembling portion 22 of the third holder 203 also has the larger aperture size Y, so that the first holder 201 can be assembled to the second holder 202, and the second holder 202 can be assembled to the third holder 203. After the assembly, the inserting tube 211 and the inserting cylinder 213 of the first holder 201 and the assembling portion 22 of the second holder 202 define an inner inserting space with the smaller size X while the assembling portion 22 of the second holder 202 and the inserting tube 211 and the inserting cylinder 213 of the third holder 203 define an inner inserting space with the larger size Y, thus defining different sizes of inserting spaces for insertion of different tool heads.

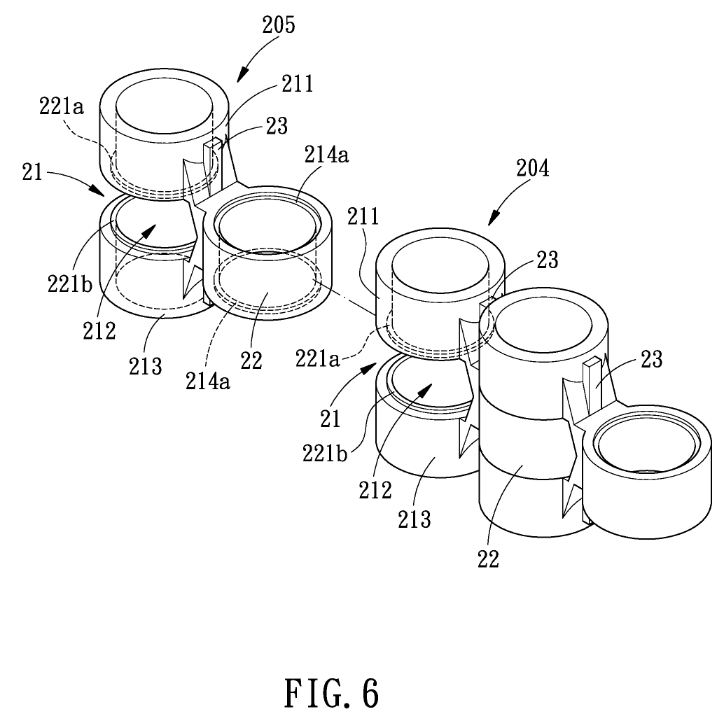

Referring to FIG. 6, the inserting tube 211 and the inserting cylinder 213 of the fourth holder 204 each are formed at one end thereof with a positioning edge 221a, 221b and the assembling portion 22 of the fifth holder 205 is defined in a opposite ends thereof with two positioning grooves 214a in such a manner that the assembling portion 22 of the fifth holder 205 can be disposed in the hollow portion 212 between the inserting tube 211 and the inserting cylinder 213 of the fourth holder 204, and the positioning edges 221a,221b of the fourth holder 204 can be engaged into the positioning grooves 214a of the fifth holder 205. In other words, the positioning edge and the positioning groove of the present invention can be disposed according to the actual requirements.

In addition, referring to FIG. 6, the tool head holder of the present invention is further formed with a protruding support block 23 on each of two end peripheries of the inserting portion 21 thereof, so that after the fourth holder 204 and the fifth holder 205 are assembled, the two support blocks 23 of the fourth holder 204 will rightly abut against the inserting tube 211 and the inserting cylinder 213 of the fifth holder 205, thus further improving the stability of the assembly between the fourth and fifth holders 204, 205.

While we have shown and described various embodiments in accordance with the present invention, it is clear to those skilled in the art that further embodiments may be made without departing from the scope of the present invention.

What is claimed is:

1. A combinable cylindrical tool head holder being made of plastic to have flexibility and comprising an inserting portion and an assembling portion, plural holders being pivotally assembled to one another to define a corresponding number of inserting spaces for insertion of tool heads; wherein:
the inserting portion is formed with an inserting tube, a hollow portion and an inserting cylinder from up down, the inserting tube is defined in an inner periphery thereof with an annular positioning groove adjacent to the hollow portion, the inserting cylinder is also defined in an inner periphery with an annular positioning groove adjacent to the hollow portion;
the assembling portion is located outside the hollow portion and in the form of a tube, the assembling portion is formed with an annular positioning edge at each of two opposite ends thereof, when two holders are assembled to each other, the assembling portion of a first holder is disposed in the hollow portion of a second holder, and the positioning edges of the first holder are engaged with the positioning grooves of the second holder, after assembly, the inserting tube and the inserting cylinder of the second holder and the assembling portion of the first holder will define an inserting space for insertion of a tool head.

2. The combinable cylindrical tool head holder as claimed in claim 1, wherein the inserting portion is externally formed with a protruding support block on each of two end peripheries thereof, after the first holder and the second holder are assembled to each other, the two support blocks of the first holder will rightly externally abut against the inserting tube and the inserting cylinder of the second holder.

3. A combinable cylindrical tool head holder being made of plastic to have flexibility and comprising an inserting portion and an assembling portion, plural holders being pivotally assembled to one another to define plural inserting spaces for insertion of tool heads, the combinable cylindrical tool head holder is characterized in that:
the inserting portion is formed with an inserting tube, a hollow portion and an inserting cylinder from up down, the inserting tube is formed at one end thereof with an annular positioning edge adjacent to the hollow portion, the inserting cylinder is also formed at one end thereof with an annular positioning edge adjacent to the hollow portion;
the assembling portion is located outside the hollow portion and in the form of a tube, the assembling portion is defined with an annular positioning edge 221 in each of two opposite ends thereof, when two holders are assembled to each other, the assembling portion of a first holder is disposed in the hollow portion of a second holder, and the positioning grooves of the first holder are engaged with the positioning edges of the second holder, after assembly, the inserting tube and the inserting cylinder of the second holder and the assembling portion of the first holder will define an inserting space for insertion of a tool head.
